(19) United States
(12) Patent Application Publication
(10) Pub. No.: US 2005/0214552 A1
(43) Pub. Date: Sep. 29, 2005

(54) Flexible metal foil-polyimide laminate and making method

(75) Inventors: Masahiro Usuki, Ibaraki-ken (JP); Michio Aizawa, Ibaraki-ken (JP); Makoto Fujiwara, Ibaraki-ken (JP); Shigehiro Hoshida, Ibaraki-ken (JP); Tadashi Amano, Ibaraki-ken (JP)

Correspondence Address: BIRCH STEWART KOLASCH & BIRCH, PO BOX 747, FALLS CHURCH, VA, 22040-0747, US

(73) Assignee: Shin-Etsu Chemical Co., Ltd.

(21) Appl. No.: 11/087,687

(22) Filed: Mar. 24, 2005

(30) Foreign Application Priority Data
Mar. 25, 2004 (JP) 2004-088824

(51) Int. Cl. C08G 69/26

(52) U.S. Cl. 428/458

(57) ABSTRACT

A flexible metal foil-polyimide laminate is prepared by applying a dimethylacetamide solution of polyamic acid onto a metal foil, drying the applied solution to form a semi-dry adhesive layer, laminating a polyimide film thereto on a hot roll press, and heat curing for solvent removal and imidization. The polyimide film has a dimethylacetamide gas permeability of at least 0.1 kg/m²·hr at 5 Torr and 200° C. In the heat curing step, the residual solvent and the water formed upon imidization in the adhesive layer are removed through the polyimide film.

### CROSS-REFERENCE TO RELATED APPLICATION

This non-provisional application claims priority under 35 U.S.C. §119(a) on Patent Application No. 2004-088824 filed in Japan on Mar. 25, 2004, the entire contents of which are hereby incorporated by reference.

### TECHNICAL FIELD

This invention relates to flexible metal foil-polyimide laminates and a method for preparing the same by a laminating technique. More particularly, it relates to a flexible metal foil-polyimide laminate having a heat resistant polyimide film stacked on one surface of a metal foil with a heat resistant adhesive layer intervening therebetween.

### BACKGROUND ART

Flexible substrates are generally prepared by directly applying a polyimide precursor resin solution onto a conductor, followed by drying and curing, as disclosed in JP-A 59-232455, JP-A 61-275325, JP-A 62-212140, and JP-A 7-57540. Also a process of applying a polyimide precursor resin solution in several divided portions onto a conductor is disclosed in JP-A 2-180682, JP-A 2-180679, JP-A 1-245586, and JP-A 2-122697.

In the process of preparing a flexible substrate by applying a polyimide precursor resin solution onto a conductor, the flexible substrate lacks the so-called “body” (or a kind of stiffness) and is awkward to handle if the thickness of the finally finished polyimide layer is less than 20 microns. Thus, the polyimide precursor resin must be thickly applied and cured to the conductor so that the finally finished polyimide layer may have a thickness of 20 microns or greater. It is difficult to apply a thick coating to a uniform thickness, often resulting in a variation of thickness, i.e., a coating failure. In this regard, the process of applying in several divided portions has a propensity that as the number of applying steps increases, thickness variations become extremely prominent.

It was then proposed in JP-A 1-244841 and JP-A 6-190967 to preform a thermoplastic polyimide film and laminate it to a conductor. In this process, the thickness of the polyimide layer becomes uniform over its extent since the thermoplastic polyimide layer is press bonded to the conductor. Especially in the process of JP-A 6-190967, a polyimide or polyamic acid solution is applied, dried and cured to form a thermoplastic polyimide/metal foil laminate, after which a polyimide film is bonded under heat and pressure to the thermoplastic polyimide side. During the heat bonding step, the thermoplastic polyimide is melted by the heat and thus corrected in thickness. The entire polyimide layer resulting from lamination of the polyimide film has a uniform thickness.

Due to a need for heat compression bonding of once cured polyimide, however, this process has to use a special apparatus capable of heating to a temperature above the Tg of polyimide and is thus uneconomical.

### SUMMARY OF THE INVENTION

An object of the invention is to provide flexible metal foil-polyimide laminates of the all polyimide type which take full advantage of a polyimide resin film having heat resistance, chemical resistance, flame retardance and electrical properties; and a method of preparing the same.

The present invention pertains to a method for preparing a flexible metal foil-polyimide laminate, comprising the steps of applying a polyamic acid solution onto a metal foil, drying the applied solution to form a semi-dry state adhesive layer, laminating a heat resistant polyimide film thereto using hot rolls, and heat curing for solvent removal and imidization. It has been found that better results are obtained when dimethylacetamide (DMAc) is used as a solvent for the polyamic acid solution, a polyimide film having a specific dimethylacetamide gas permeability is used as the heat resistant polyimide film, and in the heat curing step, the residual solvent and the water of dehydration concomitant with imidization in the adhesive layer are removed through the heat resistant polyimide film.

In one aspect, the invention provides a flexible metal foil-polyimide laminate comprising a heat resistant polyimide film and a metal foil stacked on one surface thereof with a heat resistant adhesive layer intervening therebetween, wherein the heat resistant adhesive layer is a heat resistant polyimide layer obtained by applying a polyamic acid in dimethylacetamide solvent, drying and imidizing, and the heat resistant polyimide film has a dimethylacetamide gas permeability of at least 0.1 kg/m²·hr at 5 Torr and 200° C.

In preferred embodiments, the heat resistant adhesive layer in the form of a polyimide layer has a thickness of 2 to 5 μm; the heat resistant polyimide film has a thickness of 12 to 50 μm; and the metal foil comprises a rolled copper foil or electrolytic copper foil having a thickness of 9 to 35 μm.

In another aspect, the invention provides a method for preparing a flexible metal foil-polyimide laminate, comprising the steps of applying a polyamic acid solution onto a metal foil, drying the applied solution to form a semi-dry state adhesive layer, laminating a heat resistant polyimide film thereto using hot rolls, and heat curing for solvent removal and imidization. The polyamic acid solution comprises dimethylacetamide as a solvent. The heat resistant polyimide film has a dimethylacetamide gas permeability of at least 0.1 kg/m²·hr at 5 Torr and 200° C. In the heat curing step, removal of the residual solvent and the water of dehydration concomitant with imidization in the adhesive layer takes place through the heat resistant polyimide film.

The method of the present invention for preparing a flexible metal foil-polyimide laminate of the all polyimide type using a heat resistant polyimide adhesive offers many advantages including an adhesive layer having a high bond strength despite a reduced thickness, a lower drying temperature, and a lower laminating temperature.

### BRIEF DESCRIPTION OF THE DRAWINGS

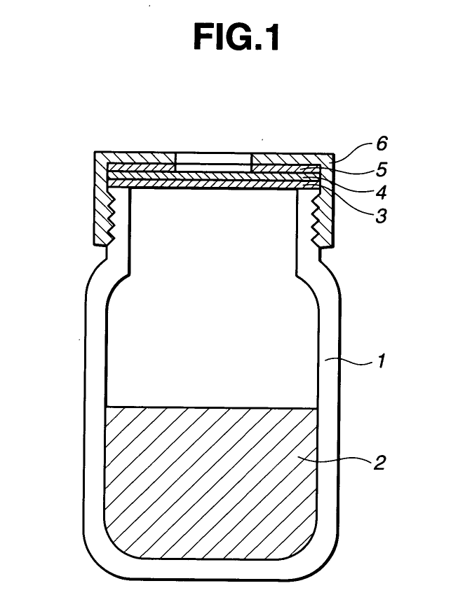

The only FIGURE, FIG. 1 schematically illustrates an assembly of measuring the DMAc gas permeability of polyimide film.

### DESCRIPTION OF THE PREFERRED EMBODIMENTS

The flexible metal foil-polyimide laminate of the invention comprises a heat resistant polyimide film having a dimethylacetamide gas permeability of at least 0.1 kg/m²·hr at 5 Torr and 200° C. and a metal foil stacked on one surface thereof via a heat resistant adhesive layer which is obtained by applying a polyamic acid in dimethylacetamide solvent, drying and imidizing.

The polyamic acid used herein as the adhesive is obtainable by reaction of aromatic tetracarboxylic anhydrides with aromatic diamines. The acid anhydrides used herein include tetracarboxylic anhydrides and derivatives thereof. Although reference is made to “tetracarboxylic acids,” it is, of course, possible to use esters, acid anhydrides and acid chlorides thereof. Examples of suitable tetracarboxylic acids include pyromellitic acid, 3,3′,4,4′-biphenyltetracarboxylic acid, 3,3′,4,4′-benzophenonetetracarboxylic acid, 3,3′,4,4′-diphenylsulfonetetracarboxylic acid, 3,3′,4,4′-diphenylethertetracarboxylic acid, 2,3,3′,4′-benzophenonetetracarboxylic acid, 2,3,6,7-naphthalenetetracarboxylic acid, 1,2,5,6-naphthalenetetracarboxylic acid, 3,3′,4,4′-diphenylmethanetetracarboxylic acid, 2,2-bis(3,4-dicarboxyphenyl)propane, 2,2-bis(3,4-dicarboxyphenyl)hexafluoropropane, 3,4,9,10-tetracarboxyperylene, 2,2-bis[4-(3,4-dicarboxyphenoxy)phenyl]propane, 2,2-bis[4-(3,4-dicarboxyphenoxy)phenyl]hexafluoropropane, butanetetracarboxylic acid, and cyclopentanetetracarboxylic acid. Trimellitic acid and derivatives thereof are also included. It is also possible to modify such a tetracarboxylic acid with a compound having a reactive functional group for introducing a crosslinked structure or ladder structure.

Examples of suitable diamines used herein include diamines such as p-phenylenediamine, m-phenylenediamine, 2′-methoxy-4,4′-diaminobenzanilide, 4,4′-diaminodiphenyl ether, diaminotoluene, 4,4′-diaminodiphenylmethane, 3,3′-dimethyl-4,4′-diaminodiphenylmethane, 3,3′-dimethyl-4,4′-diaminodiphenylmethane, 2,2-bis[4-(4-aminophenoxy)phenyl]propane, 1,2-bis(anilino)ethane, diaminodiphenylsulfone, diaminobenzanilide, diaminobenzoate, diaminodiphenyl sulfide, 2,2-bis(p-aminophenyl)propane, 2,2-bis(p-aminophenyl)hexafluoropropane, 1,5-diaminonaphthalene, diaminotoluene, diaminobenzotrifluoride, 1,4-bis(p-aminophenoxy)benzene, 4,4′-(p-aminophenoxy)biphenyl, diaminoanthraquinone, 4,4′-bis(3-aminophenoxyphenyl)diphenylsulfone, 1,3-bis(anilino)hexafluoropropane, 1,4-bis(anilino)octafluoropropane, 1,5-bis(anilino)decafluoropropane, 1,7-bis(anilino)tetradecafluoropropane, 2,2-bis[4-(p-aminophenoxy)phenyl]hexafluoropropane, 2,2-bis[4-(3-aminophenoxy)phenyl]hexafluoropropane, 2,2-bis[4-(2-aminophenoxy)phenyl]hexafluoropropane, 2,2-bis[4-(4-aminophenoxy)-3,5-dimethylphenyl]hexafluoropropane, 2,2-bis[4-(4-aminophenoxy)-3,5-ditrifluoromethylphenyl]hexafluoropropane, p-bis(4-amino-2-trifluoromethylphenoxy)benzene, 4,4′-bis(4-amino-2-trifluoromethylphenoxy)biphenyl, 4,4′-bis(4-amino-3-trifluoromethylphenoxy)biphenyl, 4,4′-bis(4-amino-2-trifluoromethylphenoxy)diphenylsulfone, 4,4′-bis(4-amino-5-trifluoromethylphenoxy)diphenylsulfone, 2,2-bis[4-(4-amino-3-trifluoromethylphenoxy)phenyl]hexafluoropropane, benzidine, 3,3′,5,5′-tetramethylbenzidine, octafluorobenzidine, 3,3′-methoxybenzidine, o-tolidine, m-tolidine, 2,2′,5,5′,6,6′-hexafluorotolidine, 4,4″-diaminoterphenyl, 4,4′″-diaminoquarterphenyl; diisocyanates obtained by reaction of the foregoing diamines with phosgene or the like; and diaminosiloxanes.

Examples of suitable solvents include N-methylpyrrolidone (NMP), dimethylformamide (DMF), dimethylacetamide (DMAc), dimethyl sulfoxide (DMSO), dimethyl sulfate, sulfolane, butyrolactone, cresol, phenol, halogenated phenols, cyclohexanone, dioxane, tetrahydrofuran, and diglyme. Of these, DMAc and NMP are preferred for solubility and shelf stability.

In the invention, DMAc is essential as the solvent. Typically DMAc accounts for 40 to 100% by volume, more preferably 80 to 100% by volume of the solvent.

The inventor made a study on the use as adhesive of a polyamic acid which is heat cured to form a polyimide adhesive layer having an identical or equivalent chemical structure and properties to the polyimide film used in the laminate. The polyamic acid which is most preferred as the adhesive is a condensate or a mixture of condensates of an acid anhydride selected from pyromellitic anhydride and 3,4,3′,4′-biphenyltetracarboxylic anhydride and a mixture thereof with an aromatic diamine selected from 4,4′-diaminodiphenyl ether and p-phenylenediamine and a mixture thereof. Condensation reaction is advantageously performed in a polar solvent of DMAc alone or a mixture of DMAc and NMP, under conditions including a reaction temperature of 10 to 40° C., a reaction solution concentration of up to 30% by weight, a molar ratio of aromatic tetracarboxylic anhydride to aromatic diamine between 0.95:1.00 and 1.05:1.00, and a N₂ atmosphere. It is understood that the methods of dissolving and adding the reactants are not particularly limited. In the practice of the invention, a copolymer or blend of polyamic acids which are obtained from the above condensates can be used as well. For the purposes of improving various properties, inorganic, organic or metallic materials in powder or fibrous form may be used in combination with the polyamic acid. It is also acceptable to add various additives, for example, antioxidants for preventing the conductor from oxidation, silane coupling agents for improving adhesion, leveling agents for improving coating characteristics, and polymers of different type for improving adhesion or the like.

The method for preparing a flexible metal foil-polyimide laminate according to the invention involves the steps of casting a polyamic acid solution onto a metal foil, typically copper foil so as to form a layer having a thickness of 2 to 5 μm after imidization, partially drying the coating at an insufficient temperature to induce imidization, for forming a semi-dry adhesive layer typically having a degree of imidization of less than 5%, especially up to 1%, laminating a polyimide film thereto on a hot roll press, and heat curing the adhesive layer for solvent removal and imidization. In this way, an all polyimide flexible metal foil laminate can be prepared without detracting from the heat resistance and other properties of the adhesive as are problematic in the prior art.

In the practice of the invention, drying of the polyamic acid solution or removal of the solvent and removal of the water of dehydration concomitant with imidization are performed through the overlying polyimide film. The polyimide film which can be used in the invention to meet this function is one having a DMAc gas permeability of at least 0.1 kg/m²·hr at 5 Torr and 200° C. If a polyimide film having a DMAc gas permeability of less than 0.1 kg/m²·hr is used, it becomes difficult to remove the solvent and the water of dehydration through the film so that the adhesive surface becomes intumesced upon heat treatment, failing to produce a desired laminate. Therefor, the polyimide film used in the laminate should have a DMAc gas permeability of at least 0.1 kg/m²·hr at 5 Torr and 200° C. and preferably a thickness in the range of 12 to 50 μm when the performance of the resulting laminate is taken into account. Prior to use, plasma treatment or etching treatment may be carried out on a surface of the polyimide film. Such polyimide films are commercially available under the trade name of Kapton V, Kapton EN and Kapton H from Toray-Dupont Co., Ltd., Apical AP and Apical NPI from Kaneka Corp, Upilex R from Ube Industries, Ltd.

The metal foil used herein is preferably a rolled copper foil or electrolytic copper foil having a thickness of 9 to 35 μm. A copper foil with a thickness of less than 9 μm is likely to wrinkle during manufacture and lacks strength in the laminating step, which thus requires to use a protective support with an undesirably increased cost.

The polyimide adhesive layer resulting from imidization of the polyamic acid should preferably have a thickness of 2 to 5 μm. An adhesive layer in excess of 5 μm is undesirable because the resulting laminate may curl noticeably.

In the practice of the invention, the polyamic acid solution or varnish is applied to one surface of a copper foil and dried. The apparatus and technique used in this step are not particularly limited. Application may be done using comma coaters, die coaters, roll coaters, knife coaters, reverse coaters, lip coaters or the like. Drying may be done at a temperature of 120° C. or lower so that the polyamic acid layer assumes a semi-dry state having a solvent content of 3 to 50% by weight and a controlled imidization, typically a degree of imidization of less than 5%, especially up to 1% at a point immediately upstream of a hot roll press. That is, the adhesive layer kept in the polyamic acid state is subject to bonding. If the solvent content is more than 50% by weight, undesirably bubbles or blisters may develop during the roll press step and the adhesive may flow, causing the rolls to be contaminated. If an adhesive layer with a solvent content of less than 3% by weight is subjected to rolling, a higher temperature and higher pressure become necessary, though partly, during lamination on the hot roll press, inviting an undesirable increase of installation cost.

The means of heating the roll press include direct heating of rolls with oil, steam or heating media. At least the roll that comes in contact with the metal foil must be heated. As to the roll material, use may be made of metal rolls such as carbon steel, and rubber rolls such as heat resistant NBR rubber, fluoro rubber or silicone rubber. The roll pressing conditions are not particularly limited. The roll temperature typically ranges from the softening point of polyamic acid in the semi-dry state to the boiling point of DMAc solvent, specifically from 100 to 150° C. The linear pressure is in a range of 5 to 100 kg/cm. With respect to the drying (solvent removal) and imidization following lamination, the temperature for solvent removal is preferably equal to or below the boiling point of the solvent used in the varnish, and the time for solvent removal is determined as appropriate until the solvent ceases to be present, usually about 3 to 30 hours, because the solvent escapes through the overlying polyimide film. The imidization may follow the solvent removal and be carried out, as in the conventional process, in a reduced pressure atmosphere having an oxygen concentration low enough to prevent the copper foil from oxidation, typically up to 2% by volume, or in a nitrogen atmosphere, at 250 to 350° C. for 3 to 20 hours. During the solvent removal and imidization, the laminate may take a sheet or roll form. In the case of roll form, how to wind into a roll is not critical, for example, the copper foil may be either inside or outside, and a spacer may be interleaved. During the solvent removal and imidization following the lamination involved in the inventive method, there will be present the residual solvent after lamination and the water formed upon imidization, which are both to be removed. Then the laminate in the preferred form of a loosely wound roll or a roll with a spacer of different material interleaved may be subjected to heat treatment.

### EXAMPLE

Examples of the invention are given below together with Comparative Example by way of illustration and not by way of limitation.

### Synthesis Example 1

Synthesis of Polyamic Acid

218.5 g of pyromellitic anhydride was added to 1 kg of N,N-dimethylacetamide (DMAc), which were stirred in a N₂ atmosphere. To the solution at 10° C., 200.5 g of 4,4′-diaminodiphenyl ether in 1 kg of N,N-dimethylacetamide was added so slowly that the internal temperature might not exceed 15° C. Reaction took place at 10-15° C. for 2 hours and then at room temperature for 6 hours. At the end of reaction, the polyamic acid varnish had a logarithmic viscosity of 0.8 dl/g as measured by Ubbelohde's viscometer at a concentration of 0.5 g/dl and 30° C.

### Examples 1 to 4

Preparation of Laminate

Using an applicator, the polyamic acid varnish prepared above was applied onto a 30 cm×25 cm piece of 35-μm rolled copper foil to a wet coating thickness of 30 μm. The coating was dried in an oven at 120° C. for 2 minutes. A 30 cm×25 cm piece of 25-μm polyimide film as shown in Table 1 was overlaid on the varnish coat. Using a test roll laminator (Nishimura Machinery Co., Ltd.), the laminate form was pressed at 120° C., a pressure of 15 kg/cm and a rate of 4 m/min. In a N₂ inert oven, the laminate form was continuously heat treated at 160° C. for 4 hours, at 250° C. for 1 hour, and then at 350° C. for 1 hour. The resulting laminate included a copper foil of 35 μm thick and a polyimide layer (adhesive layer+polyimide film) of 28 μm thick.

DMAc Permeability of Polyimide Film

As shown in FIG. 1, DMAc depicted at 2 was poured into a bottle 1 having a volume of 300 ml and a threaded open end wall. On top of the open wall, a polyimide film 3 having a thickness of 25 μm, a stainless steel mesh 4, and an annular NBR gasket 5 were disposed in alignment. A perforated cap 6 having a diameter of 26 mm was threadably engaged over the threaded wall so as to tighten the film 3, mesh 4 and gasket 5 in place. The capped bottle was placed in a vacuum oven ETACVT220 (Kusumoto Chemicals Co., Ltd.) where it was heated at 200° C. and 5 Torr for one hour. A weight loss of the solvent (DMAc) was determined and expressed in kg/m²·hr. The results are shown in Table 1.

The laminate was examined for blisters and peel strength.

Peel Strength

According to JIS C6471, a sample on which a circuit pattern of 1 mm wide was formed was measured for peel strength at a pulling rate of 50 mm/min and a peeling angle of 90°.

### Comparative Example

A laminate was prepared as in Examples except that a polyimide film of Upilex S was used.

TABLE 1

| | Example | | | | Comparative |
|---|---|---|---|---|---|
| | 1 | 2 | 3 | 4 | Example |
| Polyimide film | Kapton V | Kapton H | Kapton EN | Apical NPI | Upilex S |
| DMAc permeability | 0.27 | 0.24 | 0.16 | 0.20 | 0.06 |
| (kg/m² · hr) | | | | | |
| Blisters after | nil | nil | nil | nil | occurred |
| curing | | | | | |
| 90° peel strength | 0.65 | 0.70 | 0.78 | 0.88 | UM |
| (kg/cm) | | | | | |

UM: unmeasurable
Kapton: trade name of Toray-Dupont Co., Ltd.
Apical: trade name of Kaneka Corp.
Upilex: trade name of Ube Industries, Ltd.

Japanese Patent Application No. 2004-088824 is incorporated herein by reference.

Although some preferred embodiments have been described, many modifications and variations may be made thereto in light of the above teachings. It is therefore to be understood that the invention may be practiced otherwise than as specifically described without departing from the scope of the appended claims.

1. A flexible metal foil-polyimide laminate comprising a heat resistant polyimide film and a metal foil stacked on one surface thereof with a heat resistant adhesive layer intervening therebetween, wherein
said heat resistant adhesive layer is a heat resistant polyimide layer obtained by applying a polyamic acid in dimethylacetamide solvent, drying and imidizing, and
said heat resistant polyimide film has a dimethylacetamide gas permeability of at least 0.1 kg/m²·hr at 5 Torr and 200° C.

2. The laminate of claim 1, wherein said heat resistant adhesive layer in the form of a polyimide layer has a thickness of 2 to 5 μm.

3. The laminate of claim 1, wherein said heat resistant polyimide film has a thickness of 12 to 50 μm.

4. The laminate of claim 1, wherein said metal foil comprises a rolled copper foil or electrolytic copper foil having a thickness of 9 to 35 μm.

4. A method for preparing a flexible metal foil-polyimide laminate, comprising the steps of applying a polyamic acid solution onto a metal foil, drying the applied solution to form a semi-dry state adhesive layer, laminating a heat resistant polyimide film thereto using hot rolls, and heat curing for solvent removal and imidization, characterized in that
said polyamic acid solution comprises dimethylacetamide as a solvent,
said heat resistant polyimide film has a dimethylacetamide gas permeability of at least 0.1 kg/m²·hr at 5 Torr and 200° C., and
in the heat curing step, removal of the residual solvent and the water of dehydration concomitant with imidization in the adhesive layer takes place through the heat resistant polyimide film.
